(19) United States
(12) Patent Application Publication
(10) Pub. No.: US 2026/0340024 A1
(43) Pub. Date: Oct. 29, 2026

(54) System and Method for Context-Adaptive Multimodal Narrative Media Processing Using Dynamic Threshold Control, Cross-Modal Event Grouping, and Routing Metadata Generation

(71) Applicant: Bradford Bartlett, New York, NY (US)

(72) Inventor: Bradford Bartlett, New York, NY (US)

(21) Appl. No.: 19/658,876

(22) Filed: Apr. 27, 2026

Related U.S. Application Data
(60) Provisional application No. 63/795,224, filed on Apr. 25, 2025.
(60) Provisional application No. 63/797,048, filed on Apr. 29, 2025.
(60) Provisional application No. 63/829,726, filed on Jun. 24, 2025.

(51) Int. Cl. G06F 16/435

(52) U.S. Cl. CPC G06F 16/435

(57) ABSTRACT

The disclosure provides for a computer-implemented system and method for analyzing narrative media through multimodal signal extraction, composite scoring, adaptive threshold control, cross-modal grouping, and audit-ready output generation. In some embodiments, the system maintains a context-dependent decision state that influences subsequent scoring, association, and routing determinations across intervals. In some embodiments, the narrative media includes human-generated or machine-generated narrative content.

### CROSS REFERENCE TO RELATED APPLICATION

This application claims the benefit of and takes priority from U.S. Provisional Patent Application Ser. No. 63/795,224, filed on Apr. 25, 2025, U.S. Provisional Patent Application Ser. No. 63/797,048 filed on Apr. 29, 2025 and U.S. Provisional Patent Application Ser. No. 63/829,726 filed on Jun. 24, 2025 the contents of which are herein incorporated by reference.

### BACKGROUND OF THE INVENTION

### Field of the Invention

The disclosure relates generally to computer-implemented processing and control of narrative media, and more particularly, to systems and methods for segmenting narrative media, extracting multimodal indicators, computing composite volatility, maintaining a context-dependent decision state, dynamically adapting thresholds, sensitivity parameters, or decision criteria based on that state, associating related detections across modalities, generating evidence artifacts, and outputting routing recommendation metadata for downstream review or containment workflows.

### Description of the Related Art

Narrative media across a range of contexts, including archives, educational repositories, interviews, and other testimonial or communication environments often contain emotionally intense disclosures and references to third parties. Existing review systems typically rely on text-only toxicity scoring, sentiment analysis, keyword matching, or manual review workflows.

Such approaches do not reliably detect multimodal volatility arising from the interaction of linguistic and behavioral signals across time. They also tend to use static thresholds and often fail to produce reviewer-ready evidence showing why a segment was scored or routed in a particular way.

Accordingly, there remains a need for a technical system that can: (i) segment narrative media into time-bounded intervals, (ii) extract and fuse indicators from one or more available modalities, (iii) maintain a context-dependent decision state responsive to evolving contextual signals, (iv) adapt thresholds, sensitivity parameters, or decision criteria based on that decision state, (v) preserve provenance associated with decision-state changes, associations, and outputs, and (vi) generate structured evidence and routing metadata suitable for downstream review.

### SUMMARY OF THE INVENTION

The instant system and method, as illustrated herein, is clearly not anticipated, rendered obvious, or even present in any of the prior art mechanisms, either alone or in any combination thereof. Thus, the several embodiments of the instant apparatus are illustrated herein.

In a preferred embodiment, the disclosure provides for a computer-implemented system and method for analyzing narrative media through multimodal signal extraction, composite scoring, adaptive threshold control, cross-modal grouping, and audit-ready output generation.

In some embodiments, the system maintains a context-dependent decision state that influences subsequent scoring, association, and routing determinations across intervals.

In some embodiments, the narrative media includes human-generated or machine-generated narrative content.

In one embodiment, media including audio, video, and transcript-derived content is segmented into time-bounded intervals. Semantic indicators are extracted from transcript content, and behavioral indicators are extracted from video frames. A composite volatility score is computed from the multimodal indicators. In some embodiments, the composite volatility score includes co-occurrence weighting where multiple indicators cluster in time. In some embodiments, the composite volatility score is an Ethical Volatility Index (EVI) computed from weighted multimodal indicators and optional contextual factors, and the EVI contributes to routing recommendation metadata output.

In certain embodiments, one or more thresholds, sensitivity parameters, or decision criteria are dynamically modified based on contextual conditions associated with detected or emerging narrative signals. Contextual conditions may include proximity to high-confidence detections, partial detections, anomaly signals, pacing changes, clustering signals, or other contextual indicators derived from narrative media. The system records provenance associated with such threshold-state modification, including the triggering condition, the applicable interval, and the modified state.

Detected events may be associated into linked cross-modal event groups that capture corroborating evidence across detections derived from one or more modalities or indicator classes, including transcript-based, behavioral, anomaly-based, or contextual indicators. The system then generates evidence artifacts including timestamps, frame indices, detector metrics, transcript excerpts, and related event-group information. Routing recommendation metadata is output as structured data indicating one or more downstream containment or review pathways. The routing and action framework constitutes a governance layer that enforces policy-driven handling of narrative content based on computed indicators and system-defined criteria.

In some embodiments, semantic detections include trauma transference indicators directed toward relationally proximate third parties. In some embodiments, similarity across temporally separated narrative segments may contribute to composite scoring.

In some embodiments, downstream execution of routing recommendations is human-mediated, automated, or hybrid.

There has thus been outlined, rather broadly, the more important features of a system and method for computer-implemented processing and control of narrative media, in order that the detailed description thereof that follows may be better understood, and in order that the present contribution to the art may be better appreciated. There are additional features of the system and method that will be described hereinafter and which will form the subject matter of the claims appended hereto.

In this respect, before explaining at least one embodiment of the system and method in detail, it is to be understood that the system and method is not limited in its application to the details of construction and to the arrangements of the elements of the system and associated method set forth in the following description, and/or illustrated in the drawings. The system and method is capable of other embodiments and of being practiced and carried out in various ways. Also, it is to be understood that the phraseology and terminology employed herein are for the purpose of description and should not be regarded as limiting.

These together with other objects of the system and method, along with the various features of novelty, which characterize the system and method, are pointed out with particularity in the claims annexed to and forming a part of this disclosure. For a better understanding of the system and method, its operating advantages and the specific objects attained by its uses, reference should be made to the accompanying drawings and descriptive matter in which there are illustrated preferred embodiments of the system.

The foregoing has outlined the more pertinent and important features of the present system and method in order that the detailed description of the system that follows may be better understood, and the present contributions to the art may be more fully appreciated. It is of course not possible to describe every conceivable combination of components and/or methodologies, but one of ordinary skill in the art may recognize that many further combinations or permutations are possible. Accordingly, the novel architecture described below is intended to embrace all such alterations, modifications, and variations that fall within the spirit and scope of the appended claims.

### BRIEF DESCRIPTION OF THE DRAWINGS

The disclosure may be more completely understood in consideration of the following detailed description of various embodiments of the invention in connection with the accompanying drawings, in which:

FIG. 1 illustrates an overall system architecture including media ingestion, segmentation into time-bounded intervals, transcript and frame alignment, multimodal indicator extraction, composite volatility scoring, dynamic threshold adaptation, linked cross-modal event grouping, evidence artifact generation, and routing metadata output.

FIG. 2 illustrates an example processing flow for transcript-based semantic indicator extraction and behavioral indicator extraction, including transcript segmentation, semantic confidence computation, facial-landmark or pose-based behavioral measurement, and time alignment of the resulting detections.

FIG. 3 illustrates an example context-dependent decision state adaptation process including threshold, parameter, or decision criteria updates in which contextual conditions trigger modification of one or more thresholds, sensitivity parameters, or decision criteria, a modified state is applied within a contextual window, and threshold-state provenance is recorded.

FIG. 4 illustrates an example cross-modal event grouping process in which temporally related detections derived from one or more modalities or indicator classes, including detections derived from transcript, behavioral, anomaly, or contextual indicators, are assigned to a group identifier based on temporal overlap or proximity and stored with membership references and associated metrics.

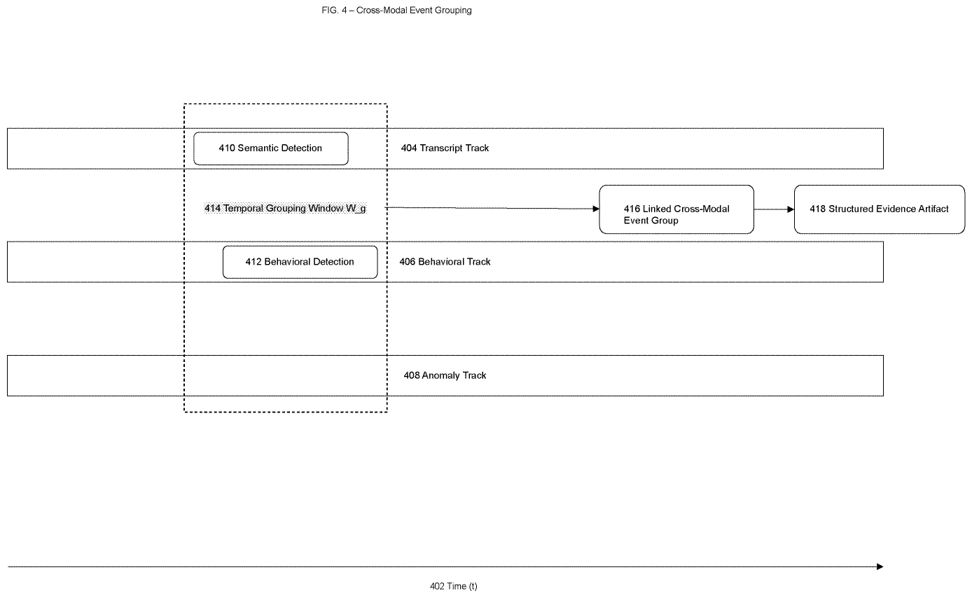

FIG. 5 illustrates an example scoring and routing process in which weighted multimodal indicators are aggregated into a composite volatility score, co-occurrence weighting is applied, evidence artifacts are assembled, and routing recommendation metadata is generated for downstream review.

### DETAILED DESCRIPTION OF THE SEVERAL EMBODIMENTS

The detailed description set forth below in connection with the appended drawings is intended as a description of several embodiments of the apparatus and does not represent the only forms in which the present apparatus may be constructed and/or utilized. The description sets forth the functions and the sequence of steps for constructing and operating the apparatus in connection with the illustrated embodiments. However, it is to be understood that the same or equivalent functions and sequences may be accomplished by different embodiments that are also intended to be encompassed within the spirit and scope of the invention.

For the following defined terms, these definitions shall be applied unless a different definition is given in the claims or elsewhere in this specification. All numeric values are herein assumed to be modified by the term “about”, whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure.

As such in this specification and the appended claims, the singular forms “a”, “an”, and “the” include plural references unless the content clearly dictates otherwise. As used in this specification and the appended claims, the term “or” is generally employed in its sense including “and/or” unless the content clearly dictates otherwise.

The following description should be read with reference to the drawings wherein like reference numerals indicate like elements throughout the several views. The drawings, which are not necessarily to scale, depict illustrative embodiments of the claimed invention.

Reference will now be made to non-limiting embodiments, examples of which are illustrated in the Figures.

### 1. System Overview

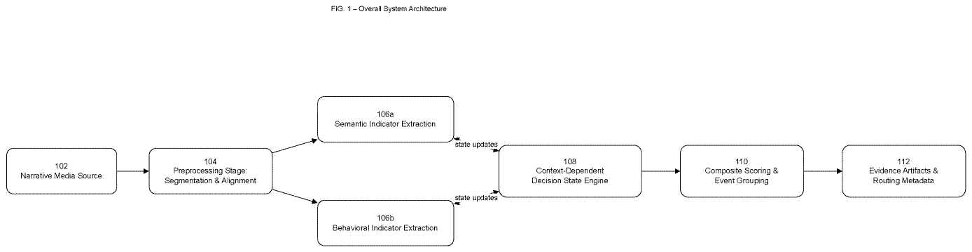

The disclosed system processes a narrative media source 102 using a multimodal analysis pipeline as illustrated in FIG. 1. The term “indicators” as used herein may include multimodal indicators or indicators derived from one or more available modalities. The pipeline may include narrative media 102 ingestion, a preprocessing stage for segmentation and alignment 104, transcript generation or normalization, semantic indicator extraction 106a, behavioral indicator extraction 106b, dynamic threshold adaptation via a context-dependent decision state engine 108, composite volatility scoring and event grouping 110, linked cross-modal event grouping, evidence artifact generation, and routing recommendation metadata output 112. In some embodiments, the multimodal indicators may further include contextual indicators derived from metadata, relationship context, historical context, pacing change, repetition, or other non-primary signals, as well as anomaly indicators derived from deviations in narrative or behavioral patterns.

The system is designed to transform raw narrative media into reviewable, evidence-backed, machine-readable outputs rather than opaque classifications.

The system is defined by the transformation of narrative media into structured, multimodal signal representations and downstream decision outputs, independent of whether such transformations are implemented through discrete modules, unified models, or hybrid systems.

In one implementation, the system is executed by one or more processors and memory in a local, server-based, or cloud-based computing environment. The hardware may include one or more CPUs, GPUs, memory modules, persistent storage, and network interfaces configured to ingest media, execute transcription and multimodal analysis, compute scores, store evidence artifacts, and output routing recommendation metadata. Different embodiments may use different model providers or analysis frameworks without changing the core processing spine of segmentation, multimodal indicator extraction, scoring, threshold adaptation, grouping, evidence generation, and routing output.

In some embodiments, one or more stages of the pipeline, including segmentation 104, semantic indicator extraction 106a, behavioral indicator extraction 106b, dynamic threshold adaptation via a context-dependent decision state engine 108, composite scoring and event grouping 110, evidence generation or routing determination 112, may be implemented or assisted using machine learning models, language models, generative models, computer vision models, or agent-based systems. Such models may operate independently at individual stages or in coordinated or agentic configurations, provided that the system maintains the multimodal signal processing, scoring, and routing structure described herein. In such embodiments, model outputs contribute to one or more indicators, scores, or decision-state updates that directly influence composite scoring, association, or routing determinations.

In some embodiments, the system maintains lineage metadata linking inputs, intermediate signals, scores, and outputs across processing stages, enabling traceability of how a given routing decision or evidence artifact was derived from source media and intermediate transformations.

In some embodiments, the system maintains a persistent or evolving decision state across successive intervals, segments, or contextual windows, the decision state including one or more threshold states, grouping states, routing states, or contextual evaluation states that govern and unify subsequent scoring, association, and routing determinations across the pipeline.

### 2. Media Ingestion and Segmentation

The system receives media data from the narrative media source 102 including, in various embodiments, audio streams, video streams, transcript text, subtitle data, or combinations thereof. Media may be pre-recorded, archived, uploaded, or streamed.

In some embodiments, the narrative media 102 may include human-generated content, machine-generated content, or combinations thereof. Machine-generated content may include outputs produced by automated systems, language models, or other generative processes. The disclosed system operates on narrative structure and multimodal signals independent of content origin, such that segmentation, indicator extraction, scoring, grouping, and routing processes are applicable to both human-generated and machine-generated narrative media.

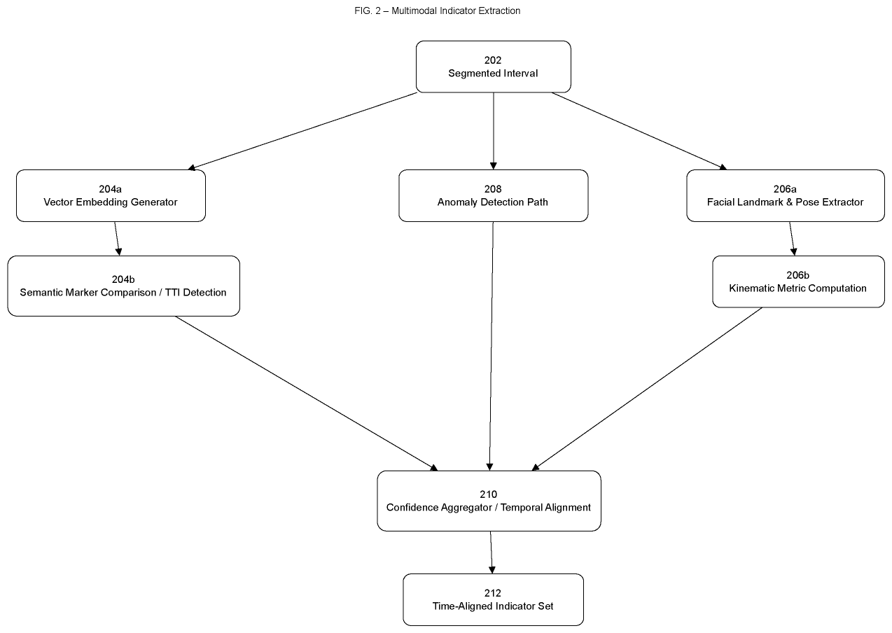

The media is segmented into time-bounded intervals as segmented intervals 202 in FIG. 2. Segmentation may be fixed-window, overlap-window, event-driven, transcript-aligned, or otherwise configured for downstream indicator extraction. In some embodiments, transcript segments are aligned to corresponding video frame ranges.

In one implementation, segmentation is performed using fixed-duration or sliding windows defined by a configurable interval Δt. Adjacent intervals may be non-overlapping or may overlap by a configurable percentage or temporal offset. In transcript-aligned implementations, transcript timestamps are used to associate text segments with corresponding frame ranges so that each analysis interval contains time-aligned transcript content and visual data. In certain implementations, segmentation boundaries may also be adjusted based on pauses, punctuation, or signal discontinuities to improve alignment between semantic and behavioral signals.

In some embodiments, the system is configured to rescan previously stored, archived, or distributed narrative media as marker sets, threshold settings, or routing rules evolve.

In some embodiments, the system operates on streaming or real-time media inputs, performing segmentation, indicator extraction, scoring, and routing on continuously received data, including near real-time or asynchronous processing modes.

### 3. Semantic Indicator Extraction

Semantic indicators are extracted from transcript content within a transcript track 404 over Time (t) 402. In some embodiments, transcript portions are normalized and transformed into vector representations, embeddings, tokenized structures, or other machine-processable forms by a vector embedding generator 204a. At step 204b, the system compares transcript content against one or more semantic marker sets, conceptual marker sets, or learned representations to compute confidence scores.

In one implementation, transcript segments are encoded into vector representations using embedding-based models via the vector embedding generator 204a, and semantic similarity is computed relative to one or more marker sets or learned reference representations using cosine similarity or another similarity or distance function. A semantic confidence score may be computed from one or more of semantic similarity, relational-reference detection, evaluative or judgmental language detection, discourse structure, and contextual modifiers.

In some embodiments, semantic detections include trauma transference indicators (TTI) detection 204b associated with evaluative or judgmental references to relationally proximate third parties. In such embodiments, target attribution may be inferred from contextual indicators present in the narrative segment sufficient to associate a detected event with a non-speaker target. A trauma transference indicator may be detected when transcript content includes a relationally proximate third-party reference together with evaluative or judgmental language and sufficient semantic confidence, optionally during a rupture-associated interval. In certain implementations, such detections may exclude generalized adversarial or non-targeted statements. A representative TTI confidence formulation may combine semantic similarity, relational-reference score, judgment-language score, emotional-intensity score, and optional behavioral corroboration occurring within a defined temporal window. This representative formulation describes one way of combining disclosed TTI signal classes and does not require any single rigid equation.

In some embodiments, anomaly indicators may be derived via an anomaly detection path 208 from an anomaly track 408 over Time (t) 402 based on deviations from baseline narrative patterns, including prolonged silence, speech-rate change, disfluency, pacing irregularity, or other irregular signal behavior. In such embodiments, anomaly detection path 208 may compare segment-level features against a baseline or local reference distribution using one or more of pause density, filler-word frequency, part-of-speech entropy, sentiment volatility, pacing irregularity, and deviation of a segment embedding from a reference embedding centroid. An anomaly score may be generated using statistical outlier detection, entropy-based analysis, clustering, or density-based methods.

In some embodiments, anomaly or semantic indicators include detection of inconsistencies, hallucinated content, or synthetic narrative artifacts associated with machine-generated outputs.

### 4. Behavioral Indicator Extraction

Behavioral indicators extraction 106b may performed on video frames or time-aligned visual data within a behavioral track 406 over Time (t) 402. Such indicators may include head motion, head bow, gaze deviation, eye closure, pose-derived metrics, or other visually detectable somatic signals.

In one implementation, behavioral indicators are derived using computer vision processing that extracts facial landmarks, pose information, or motion trajectories across frames via a facial landmark and pose extractor 206a. For head-bow detection, the system may estimate head pose from facial landmarks, compute a pitch-angle or analogous pose-derived metric over time through kinematic metric computation 206b, smooth the resulting sequence, and identify threshold crossings or z-score deviations relative to a local baseline. For eye-closure detection, the system may compute an eye-aspect-ratio type measure from eyelid landmarks through kinematic metric computation 206b, identify sustained closure across consecutive frames via a facial landmark and pose extractor 206a, and record corresponding timestamps and frame indices. Frame-level outputs may be aggregated into segment-level behavioral scores using averaging, peak detection, weighted accumulation, or temporal persistence logic.

In some embodiments, the system records frame-level measurements, timestamps, confidence values, or derived metrics corresponding to the behavioral indicators.

### 5. Composite Volatility Scoring

The system at step 110 computes a composite volatility score from the multimodal indicators. The composite volatility score may be derived from weighted aggregation of semantic indicators, behavioral indicators, contextual indicators, anomaly indicators, or other signal classes. Contextual indicators may include metadata, relationship context, historical context, pacing change, repetition, or other non-primary signals associated with narrative volatility.

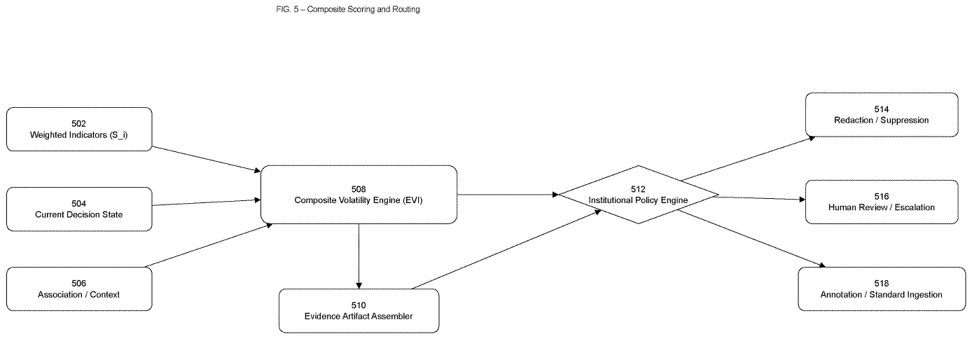

In one implementation, as shown in FIG. 5, the composite volatility score is computed as a weighted aggregation of multiple signal classes provided as weighted indicator S_i 502 to a composite volatility engine (EVI) 508. The score is calculated as:

S_comp=Σ w_i·S_i

where S_i represents one or more normalized or unnormalized signal components, including semantic confidence, behavioral confidence, anomaly score, contextual score, or other configured signal classes, and w_i represents configurable weights. Input signals may be normalized before aggregation, and the scoring flow may include input signal extraction, optional normalization, weighting, aggregation, and output of a segment-level composite score.

In some embodiments, the composite volatility score includes co-occurrence weighting such that temporally clustered indicators increase the score relative to isolated detections. Co-occurrence weighting may be applied by adding or scaling the composite score when two or more detections from different modalities occur within a defined temporal proximity window. The co-occurrence logic may be represented by an additional term, scaling factor, or bonus value, and may be omitted in lighter-weight embodiments.

Accordingly, the representative scoring formulation may include additional or fewer components, and weights may be static, configurable, or dynamically adjusted.

In embodiments using the Ethical Volatility Index (EVI), the EVI may be computed from weighted multimodal indicators, optionally including co-occurrence weighting and contextual factors, and may contribute to routing recommendation metadata 112.

In some embodiments, the composite volatility score further incorporates a reflection metric derived from a nonlinear transformation of similarity scores across temporally separated narrative segments, the reflection metric contributing to composite scoring or routing recommendation metadata 112.

Decision outputs may be derived from scores, classifications, rankings, or other evaluative representations of multimodal indicators. In some embodiments, the evaluative representation is derived from a subset of available signal classes, modalities, or contextual inputs, including text-only, video-only, audio-only, or other reduced-input configurations, while preserving adaptive scoring or routing behavior.

### 6. Dynamic Threshold Adaptation With Provenance

In some embodiments, threshold modification is implemented as an update to a context-dependent decision state engine 108 governing subsequent evaluation. The context-dependent decision state engine 108 functions as a control layer that mediates how subsequent indicators are interpreted, weighted, or acted upon within the pipeline.

The system may modify one or more detection thresholds, sensitivity parameters, or decision criteria based on contextual conditions associated with detected or emerging narrative signals. Contextual conditions may include proximity to high-confidence detections, partial detections, anomaly signals, pacing changes, clustering signals, or other contextual indicators derived from narrative media. For example, when a current interval falls within a proximity window relative to a high-confidence semantic detection, the system may increase or otherwise alter detector sensitivity for behavioral detection within that interval.

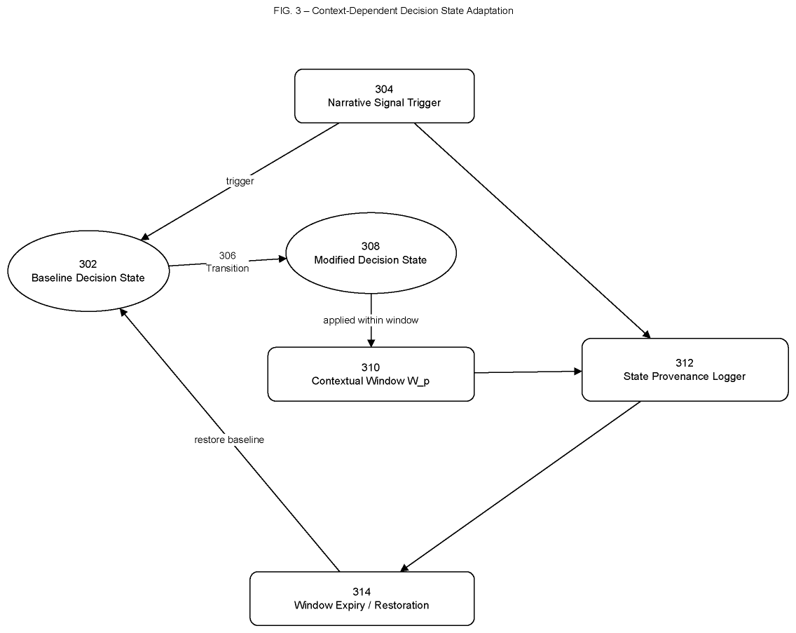

In one implementation, as shown in FIG. 3, threshold modification follows a trigger-to-effect structure. A triggering condition may include a narrative signal trigger 304 such as a high-confidence semantic detection, a composite score exceeding a threshold, an anomaly signal, or a clustering condition. In response, as a part of modified decision state 308, the system may modify one or more parameters, including lowering or raising a detector threshold, modifying score weighting, or adjusting a routing threshold. The modification may be applied within a temporal proximity window W_p 310 surrounding the triggering event and may persist for the duration of that window, after which the baseline state may be restored or replaced by another configured state. A representative rule may be: if a semantic or composite score exceeds threshold T_high within window W_p, then behavioral detection threshold T_beh or another detector parameter is modified for that window.

In some embodiments, modification of detection thresholds, sensitivity parameters, or decision criteria may be implemented through predefined profiles, rule-based selection, continuous scaling, probabilistic adjustment, model-assisted parameter selection, or machine-learning-based adjustment responsive to contextual inputs.

In some embodiments, the dynamic adaptation is performed at runtime through context-triggered modification of thresholds, sensitivity parameters, or decision criteria, without requiring retraining of an underlying model.

In some embodiments, the adapted evaluation criteria are represented implicitly through model state, learned decision boundaries, latent decision parameters, or other non-explicit parameterizations rather than discrete threshold values. In some embodiments, the adaptive control may be applied at detector-level, composite-score-level, or routing-decision-level decision boundaries within the pipeline.

The system records provenance associated with threshold-state modification using a state provenance logger 312. Provenance depth may vary by implementation and may include one or more of a triggering event identifier, an interval of application, a baseline state, a modified state, contextual conditions, and detector-specific parameter information. In some embodiments, the modified state is stored in memory for the duration of the applicable contextual window and is applied to subsequent or context-adjacent evaluations occurring within that window.

Outside the applicable contextual window, the system may restore the baseline threshold state or apply a different state according to system configuration.

Adaptation affects subsequent or context-adjacent evaluation rather than the triggering computation itself.

### 7. Linked Cross-modal Linked Event Groups

The system forms linked cross-modal event groups 416 associating temporally related detections across modalities. A cross-modal linked event group 416 may include one or more detections derived from transcript, behavioral, anomaly, or context-based indicators occurring within a defined temporal relationship. In some embodiments, associations are maintained without forming explicit groups, including through shared decision state or contextual linkage.

In one implementation, grouping is performed using a configurable temporal grouping window W_g 414. Detections are candidates for grouping when their timestamps overlap or when their time spans fall within W_g 414 of one another. A detection may be assigned to an existing group when overlap or proximity criteria are satisfied relative to one or more members of that group, and a new group identifier may be created when no existing group satisfies the grouping criteria. Grouping criteria may additionally include minimum signal confidence or modality diversity requirements. Each group may maintain a unique group identifier, membership references, group time span, associated scores, excerpts, and provenance links.

In one implementation, when a detection satisfies grouping criteria for multiple candidate groups, assignment is determined based on a priority rule including temporal proximity, signal confidence, or group cohesion metrics, and group membership may be updated dynamically as new detections are incorporated.

In some embodiments, each linked cross-modal event group includes a group identifier and membership structure. The group may store references to associated detections, detector metrics, timestamps, excerpts, and related provenance data.

In some embodiments, relationships among detections, entities, and temporal segments are represented using a relational or graph-based structure, in which nodes correspond to detected events, entities, or segments, and edges represent temporal proximity, semantic similarity, or contextual relationships. Such representations may be used to support traversal, grouping, or inspection of related events across modalities and time.

In some embodiments, detected events, entities, and relationships are represented within a structured relational or graph-based data model, enabling traversal, aggregation, and visualization of connections across segments, modalities, and narrative contexts. This grouping mechanism enables downstream reviewers or systems to inspect corroboration structure across modalities rather than isolated events. In some embodiments, related detections are associated without forming an explicit named group identifier, including through contextual linkage, relational association, or shared decision state across temporally related detections.

### 8. Evidence Artifact Generation

For each detected event or linked cross-modal event group 416, the system generates one or more evidence artifacts, such as the structured evidence artifact 418. Evidence artifacts may include timestamps, transcript excerpts, frame indices, verification frames, detector metrics, similarity scores, group identifiers, and threshold-state provenance.

The evidence artifacts may be included in structured outputs, reports, review interfaces, or exported records. In some embodiments, the evidence artifacts are rendered into reports that include event lists, score breakdowns, linked-event displays, detector metrics, and verification frames corresponding to peak events.

In some embodiments, the system supports reconstruction of a decision trace for a given event or segment, including the sequence of extracted indicators, intermediate scores, threshold states, grouping associations, and routing determinations that contributed to an output. The decision trace may be stored, rendered, or replayed to enable audit, verification, or review of system behavior.

In some embodiments, the system maintains a traceable record of decision states, including input signals, intermediate scores, threshold states, grouping assignments, and routing outputs, enabling reconstruction and audit of system behavior.

In some embodiments, the system maintains a reconstructable decision trace in which each routing determination is traceably linked to extracted indicators, intermediate scores, and the decision state active during evaluation.

### 9. Routing Recommendation Metadata Output

The system outputs routing recommendation metadata 112 indicating one or more downstream pathways associated with a detected event or linked cross-modal event group 416. The routing recommendation metadata may include a recommended category, route confidence, associated evidence references, score information, or other structured output fields.

In one implementation, routing recommendation metadata is generated by comparing the composite volatility score via the composite volatility engine 508 and related contextual fields against one or more routing rules within an institutional policy engine 512. In some embodiments, routing determinations are generated further based on the current decision state 504 of the system, including one or more modified threshold states, group associations or contextual states 506, or prior routing states associated with the evaluated segment or a related segment. A representative routing rule set governed by the institutional policy engine 512 may assign annotation or standard ingestion 518 to lower-risk segments, human review 516 to medium-risk or ambiguous segments, redaction 514 to segments involving non-consensual third-party exposure or other configured harmful-content conditions, suppression 514 to higher-severity segments exceeding a configured threshold, and escalation 516 to segments satisfying predefined severity or policy criteria. Routing decisions may be implemented using rule-based logic, decision trees, weighted rule engines, or configurable institutional rule sets.

In some embodiments, routing recommendation metadata indicates one or more of annotation, review, redaction, suppression, or escalation. In some embodiments, downstream execution is performed by a human reviewer, is automated, or is hybrid.

Routing actions may include policy-driven modification of data access, visibility, prioritization, distribution, or downstream processing, including filtering, tagging, access control, or notification.

In some embodiments, routing recommendation metadata is generated as structured machine-readable output fields for downstream systems, independent of whether any downstream action is automatically executed.

In some embodiments, routing determinations may be executed directly by automated or agent-based systems to perform one or more actions including redaction, suppression, annotation, access control, or notification, in either real-time or asynchronous processing contexts.

In some embodiments, routing decisions are governed by configurable policy definitions that may be expressed as rule sets, logic conditions, or policy-as-code representations. Such policies may be versioned, updated, or customized by an institution and applied to scoring outputs to determine routing outcomes, containment actions, or review pathways.

In some embodiments, access to evidence artifacts, routing outputs, or system functions is controlled through role-based or permissioned access mechanisms, and actions performed within the system may be logged for audit and governance purposes.

### 10. Implemented and Configurable Embodiments

In one implementation, the system includes media ingestion, transcript generation or normalization, transcript-based semantic indicator detection, behavioral detection including head bow and eye closure, composite scoring with co-occurrence weighting, dynamic threshold adaptation with recorded provenance, linked cross-modal event grouping, report generation, and routing recommendation metadata output.

Configurable aspects may include marker sets, score weights, threshold values, routing policies, detector model choices, report formatting, and downstream execution modes.

In some embodiments, the system incorporates feedback from downstream review outcomes to update scoring weights, detection parameters, routing criteria, or model components, including through supervised, semi-supervised, or reinforcement-based learning processes.

In some embodiments, reviewer input or downstream outcomes may be incorporated to adjust thresholds, weights, or routing criteria over time.

In some embodiments, the system supports multi-tenant deployments in which different institutions or users may define distinct policy configurations, thresholds, or routing rules while operating on shared infrastructure.

### 11. Alternative Embodiments

In some embodiments, similarity across temporally separated narrative segments may contribute to composite scoring or routing recommendation metadata. In some embodiments, institution-specific rulesets or review preferences may influence how scores are interpreted for routing. In some embodiments, the system may operate on stored content, streaming content, or both.

What is claimed is:

1. A computer-implemented method comprising:
receiving a set of media data comprising narrative media signals including one or more of transcript-derived data, video-derived data, audio-derived data, or other modality-derived indicators;
segmenting the media data into time-bounded intervals;
extracting one or more indicators from one or more available modalities associated with the intervals, the indicators including, in some embodiments, semantic indicators derived from transcript content and behavioral indicators derived from video frames;
maintaining a context-dependent decision state based on contextual conditions associated with detected or emerging narrative signals, the decision state including one or more thresholds, sensitivity parameters, decision criteria, group associations, or contextual evaluation states;
computing a composite volatility score or evaluative representation based on the one or more indicators using the context-dependent decision state;
associating related detections through linked cross-modal event groups, contextual associations, or shared decision state;
generating one or more evidence artifacts associated with the related detections;
recording provenance associated with the decision state, including at least a triggering condition and an interval of application; and
outputting routing recommendation metadata based on the composite volatility score or other evaluative representation and on the decision state, including traceable linkage to one or more associated detections, grouping associations, or contextual states.

2. A system comprising:
one or more processors; and
memory storing instructions that, when executed by the one or more processors, cause the one or more processors to:
ingest media data comprising narrative media signals including one or more of transcript-derived data, video-derived data, audio-derived data, or other modality-derived indicators;
segment the media data into time-bounded intervals or otherwise associate portions of the media data with corresponding contextual windows;
detect one or more indicators from one or more available modalities;
maintain and update a context-dependent decision state responsive to detected indicators and contextual conditions;
generate a composite volatility score or other evaluative representation using the decision state;
associate related detections through linked cross-modal event groups, contextual associations, or shared decision state;
generate evidence artifacts and provenance records corresponding to the evaluative representation and associated detections; and
output routing recommendation metadata based on the evaluative representation and the decision state.

3. A non-transitory computer-readable medium storing instructions that, when executed by one or more processors, cause the one or more processors to:
receive media data comprising narrative media signals including one or more of transcript-derived data, video-derived data, audio-derived data, or other modality-derived indicators;
segment the media data into time-bounded intervals;
extract one or more indicators from one or more available modalities associated with the intervals;
maintain a context-dependent decision state responsive to detected indicators and contextual conditions associated with detected or emerging narrative signals;
compute a composite volatility score or other evaluative representation based on the one or more indicators using the decision state;
associate related detections through linked cross-modal event groups, contextual associations, or shared decision state;
generate one or more evidence artifacts associated with the related detections;
record provenance associated with the decision state, including at least a triggering condition and an interval of application; and
output routing recommendation metadata based on the evaluative representation and the decision state.

4. The method of claim 1, wherein the behavioral indicators are selected from the group consisting of at least one of a head motion, gaze deviation, pose-derived metrics, and other visually detectable signals.

5. The method of claim 1, wherein the composite volatility score further comprises a co-occurrence weighting when multiple multimodal indicators occur within a temporal proximity window.

6. The method of claim 1, wherein the semantic indicators further comprise a set of trauma transference indicators associated with references to relationally proximate third parties.

7. The method of claim 1, wherein the provenance further comprises a baseline state and a modified or context-adjusted decision state associated with the decision state.

8. The method of claim 1, wherein the linked cross-modal event group comprises a group identifier and membership references linking detections derived from one or more modalities or indicator classes, selected from the group consisting of: transcript-derived, behavioral-derived, anomaly-derived, and context-derived detections.

9. The method of claim 1, wherein the one or more evidence artifacts is selected from the group consisting of: timestamps, frame indices, transcript excerpts, verification frames associated with detected behavioral events, and detector metrics.

10. The method of claim 1, wherein the routing recommendation metadata identifies at least one selected from the group consisting of: annotation, review, redaction, suppression, and escalation.

11. The system of claim 2, wherein the semantic matching further comprises a similarity analysis against one or more conceptual marker sets.

12. The system of claim 2, wherein the system restores a baseline detection parameter state outside a contextual proximity window.

13. The system of claim 2, wherein the instructions further cause the one or more processors to generate a report including at least one of score information, linked cross-modal event group information, and evidence artifacts.

14. The system of claim 2, wherein routing recommendation metadata is supplied to a downstream review queue or containment workflow system.

15. The system of claim 2, wherein similarity across temporally separated narrative segments contributes to composite volatility scoring or routing recommendation metadata.

16. The method of claim 1, wherein the media data comprises previously recorded archival content and rescans the previously recorded archival content as marker sets, threshold settings, or routing rules evolve.

17. The method of claim 1, wherein the contextual conditions are selected from the group consisting of: at least one of contextual proximity to a high-confidence semantic detection, partial detections, anomaly indicators, pacing changes, and clustering signals.

18. The method of claim 1, wherein the one or more thresholds, sensitivity parameters, and/or decision criteria are modified utilizing a predefined profile, continuous scaling, or probabilistic adjustment.

19. The method of claim 1, wherein the one or more thresholds, sensitivity parameters, or decision criteria are modified using model-assisted parameter selection, machine-learning-based adjustment, or agentic control logic responsive to contextual inputs.

20. The method of claim 1, wherein the thresholds or decision parameters are represented within the context-dependent decision state, including detector-level thresholds, composite-score weighting, routing thresholds, or action thresholds.

21. The method of claim 1, wherein the context-dependent decision state persists across multiple successive intervals, segments, or contextual windows and influences subsequent scoring, association, or routing determinations.

22. The method of claim 1, wherein the decision state includes explicit thresholds, implicit learned decision boundaries, latent decision parameters, or combinations thereof.

23. The method of claim 1, wherein the evaluative representation is derived from fewer than all available modalities or signal classes, including text-only, audio-only, video-only, or contextual-input-only configurations.

24. The system of claim 2, further comprising a configuration interface through which institution-specific thresholds or routing preferences are supplied.
